(19) United States
(12) Patent Application Publication
(10) Pub. No.: US 2010/0016134 A1
(43) Pub. Date: Jan. 21, 2010

(54) Hott matt

(76) Inventor: Jason Peter Reese, Boise, ID (US)

Correspondence Address: Jason Peter Reese, 249 E Pennsylvania St., Boise, ID, 83706, US

(21) Appl. No.: 12/460,498

(22) Filed: Jul. 20, 2009

Related U.S. Application Data
(60) Provisional application No. 61/135,404, filed on Jul. 21, 2008.

(51) Int. Cl. A63B 21/00; B32B 3/06

(52) U.S. Cl. 482/131; 428/104

(57) ABSTRACT

The invention is an exercise apparatus consisting of a modified workout mat, attachable rubber resistance bands, and interchangeable handles and ankle straps which can be connected to the resistance bands. The exercise mat has nylon straps with metal rings sewn onto it so that rubber resistance bands of various lengths and weights can be attached to the sides of the mat to provide a multitude of workout options. There are also nylon straps sewn onto the underside of the mat which are used to anchor it to an object such as a bench or chair to provide the user with a wider variety of workout positions. The mat is of a tri-fold design so it can be easily folded up for transport or storage. Taken as a whole, the modified workout mat, resistance bands, and various attachments can be used in combination to provide a convenient and complete body workout.

### CROSS-REFERENCE TO RELATED APPLICATIONS

I claim priority to my Provisional Application Ser. No. 61/135,404

### STATEMENT REGARDING FEDERALLY SPONSORED RESEARCH OR DEVELOPMENT

The inventor has no funding agreements and is in no way connected to a Federal agency regarding sponsored research or development.

### BACKGROUND OF THE INVENTION

The use of rubber tubing as resistance bands for exercise has gained popularity over the past few years. Likewise, the use of padded foam mats in exercise routines has also become very popular. Both pieces of exercise equipment, however, have always been considered two separate workout implements. Having been a practitioner of both pieces of exercise equipment, the inventor came to the conclusion that the two different workout implements (resistance bands and exercise mats) could be combined in a specific manner to create a more effective and convenient piece of workout equipment. After conducting an extensive search of gyms, sporting goods stores, and the internet for this type of workout equipment and not finding anything resembling a padded mat with attachments for resistance bands, the inventor decided to create the workout apparatus himself.

### BRIEF SUMMARY OF THE INVENTION

Hott Matt is a workout kit that includes a unique workout mat, modified rubber resistance bands, and custom hand and ankle attachments. The mat is unique in that it has metal rings attached to the sides of it at specific locations. The foam padding of the mat is covered with a thin, durable nylon fabric and is divided into three equal sections so that it can be folded up. Specially designed resistance bands can be easily attached to and removed from the metal rings on the sides of the mat with the use of carabiners that are fastened to both ends of the resistance cables. With one end hooked to a metal ring on the mat, a handle grip or velcro ankle band with a metal ring attached to it can be hooked to the carabiner at the opposite end of the resistance cable. Once attached, the user positions his or herself on the mat and uses the handles or ankle straps to pull against the resistance of the rubber cables.

In addition to the metal rings, the specially designed workout mat comes equipped with nylon belt straps attached to the bottom side of the mat. These belts can be used to anchor the mat to a solitary object such as a bench or chair. Once anchored to the object, the belt straps provide added support against the pressure that is applied to the metal rings when the resistance cables are stretched out.

The resistance cords included in the Hott Matt workout kit come in varying lengths and resistance weights. This variety allows the user to choose a specific length and resistance weight to use depending on the amount of space and resistance force needed to stretch the cord through the workout motion.

Taken as a whole, the combination of the numerous locations of the metal rings attached to the mat, the variety of different lengths and weights of the resistance cords, and the option of handles or ankle bracelet straps, can all be used together to provide a full-body workout in a small amount of space.

The qualities that make Hott Matt special are its convenience and accessibility. Hott Matt can be used anywhere that there is enough room to stretch out a rubber resistance band: in the house, in the office, in the car, and anywhere outside. Hott Matt can also be used in combination with common implements to enhance one's workout. For example, it can be attached to a bench, used in a seated position over the top of a chair, anchored to a vertical support, or simply laid out flat on the floor. And finally, unlike bulky workout machines or heavy workout equipment, Hott Matt can easily be broken down and folded up for transport or storage.

### BRIEF DESCRIPTION OF THE SEVERAL VIEWS OF THE DRAWING

FIG. 1 is an overhead view of the top side of the mat with the metal rings (1) and the nylon straps (2) extended outward at the sides.

FIG. 2 is an overhead view of the bottom side of the mat with the nylon straps (2) and the metal rings (1) extended out to the sides. The nylon belt straps (3) are unhooked and laid out flat at the sides.

FIG. 3 is a side view of the mat that shows where it is divided into three equal sections. None of the nylon and metal attachments have been included in the drawing for better clarity.

FIG. 4 is a side view of one of the manners in which the mat can be folded to conform to the shape of a solid object such as a chair. None of the nylon and metal attachments have been included in the drawing for better clarity.

FIG. 5 is a side view of the mat completely folded up for transport or storage. None of the nylon and metal attachments have been included in the drawing for better clarity.

FIG. 6 is a close-up view of one of the metal rings (1) connected to one of the nylon straps (2) that are attached to the mat.

FIG. 7 is an overhead view of one of the nylon belt straps (3) laid out flat as it appears before it has been sewn onto the backside of the mat.

FIG. 8 is a side view of one of the resistance bands and its components. One end of the band has been rotated ninety degrees to show the inside of the nylon loop strap (10).

FIG. 9 is an overhead view of one of the workout handles and its components.

FIG. 10 is a side view of one of the ankle bracelet straps and its components.

### DETAILED DESCRIPTION OF THE INVENTION

Hott Matt is a workout kit that includes a workout mat, rubber resistance cables and hand and ankle attachments. The centerpiece of Hott Matt is a rectangular workout mat measuring approximately 2′ wide by 4′6″ long.

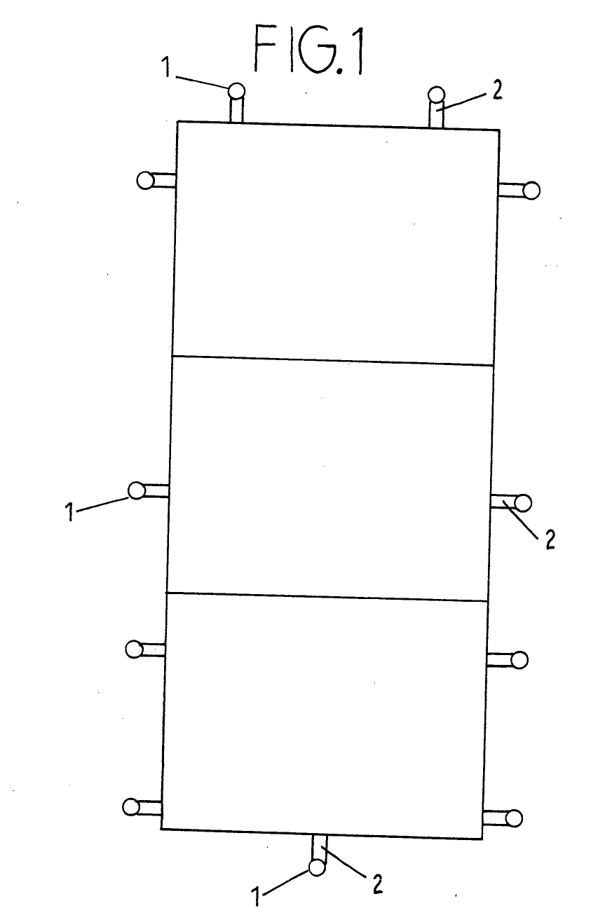

As shown in FIG. 1, the mat has eleven metal rings (1) that hang off the sides of the mat on nylon straps (2) that stick out approximately 2″ from the edges of the mat.

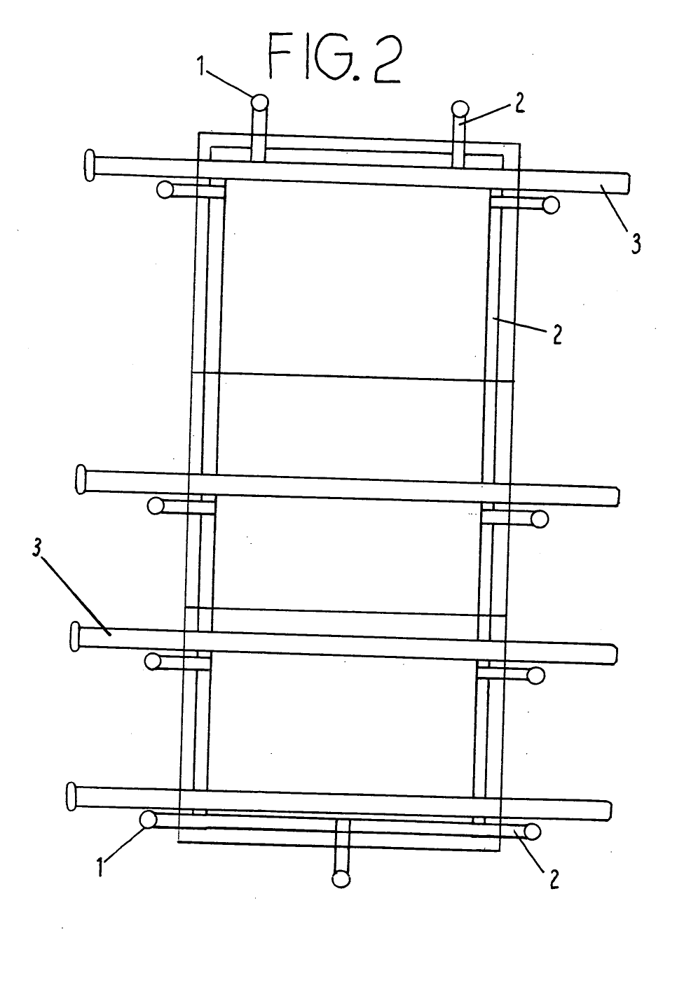

The backside of the mat, as seen in FIG. 2, has thirteen 1″ thick nylon straps (2) sewn onto it. These nylon straps provide support for the metal rings (1) that hang off the sides of the mat. In addition to the thirteen nylon straps (2), there are four 1.5″ nylon belt straps (3) that are also sewn onto the backside of the mat.

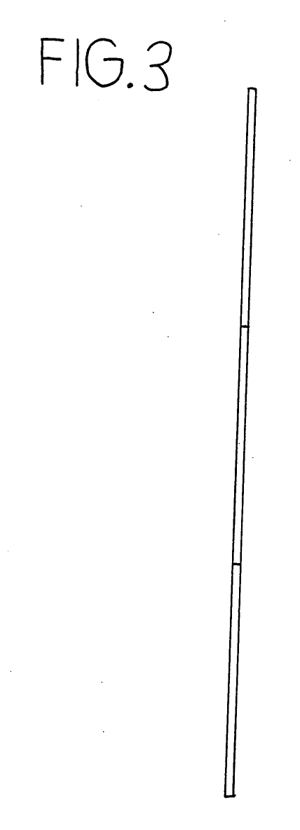

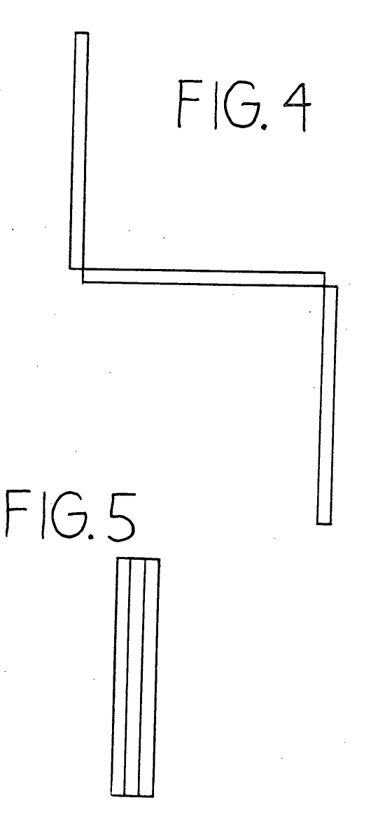

As seen in FIG. 3, the mat is actually made up of three equal sections of foam padding that are covered with a thin nylon shell. By separating the mat into three parts, it can be bent to fit over the top of a curved object like a chair (FIG. 4) or it can be folded up completely for transport or storage (FIG. 5).

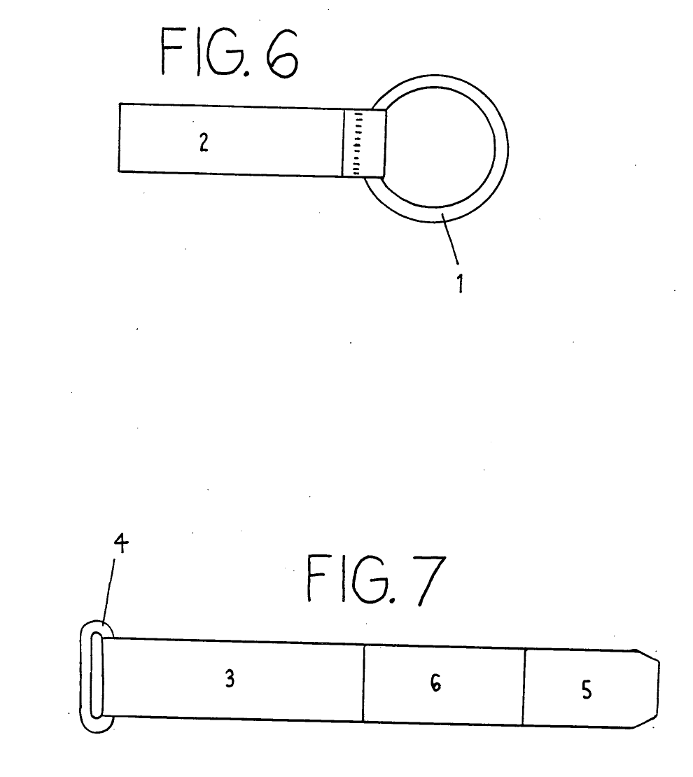

As seen in FIG. 6, the metal rings (1) are connected to the nylon straps (2) by threading the end of the strap through the center of the metal ring, then doubling the strap back over itself and stitching it back onto the itself.

FIG. 7 shows one of the nylon belt straps (3) that are sewn onto the backside of the mat. These belt straps (3) are used to anchor the mat to another object and are approximately 5′ long. They have a plastic buckle attached to one end (4) and velcro sewn onto the opposite end. The belts are used by wrapping them around a solid object, running the end of the strap through the plastic buckle at the opposite end of the strap (4), and then doubling it back over itself and pressing the coarse velcro (5) down on the soft velcro (6) until they are sufficiently stuck together. Starting at the end of the strap, there is approximately 6″ of coarse velcro (5) followed by 12″ of soft velcro (6).

In addition to the workout mat, Hott Matt includes twelve workout resistance bands. Each resistance band is made up of three components: a piece of rubber tubing, two modified nylon straps, and two aluminum carabiner clips.

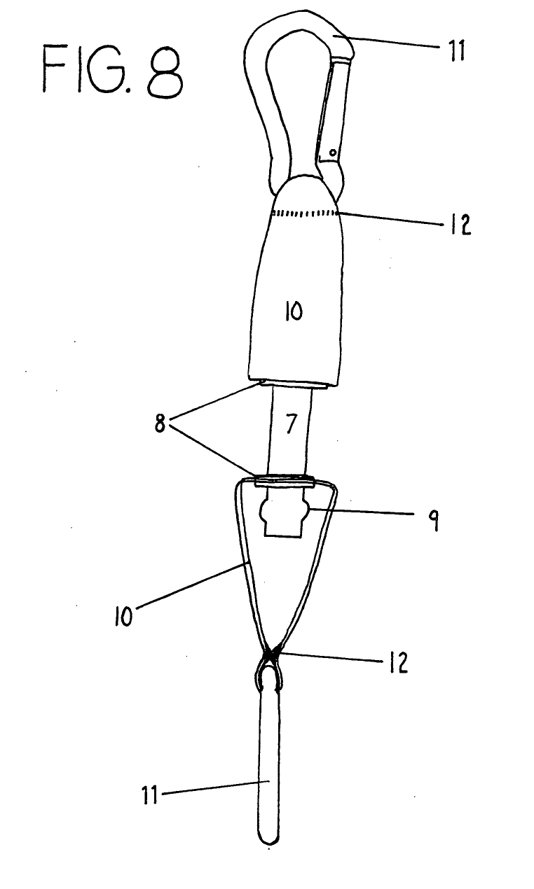

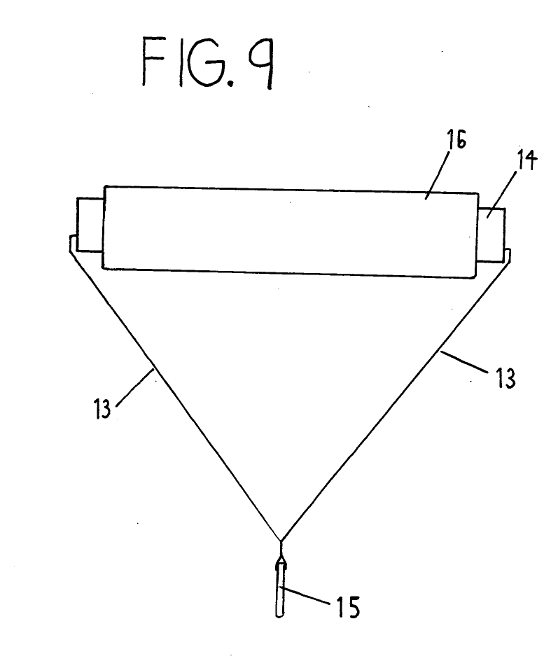

As seen in FIG. 8, the resistance band starts with a piece of rubber tubing (7). Both ends of the rubber tube (7) are fed through small metal rings (8) and then widened with a small plastic ball (9) to prevent the tubing from sliding back through the metal ring. Each metal ring (8) is embedded into the middle of a 6″ long looped strap of 1″ wide nylon webbing (10). At the opposite end of the loop of nylon webbing, a small aluminum carabiner is attached (11). The nylon loop strap (10) is then stitched together (12) to prevent the carabiner clip from sliding.

While each resistance band has the same style of nylon strap (10) and the same style of carabiner clip (11), the rubber tubing (7) comes in varying lengths and resistance weights to provide the user with a wide variety of resistance workout combinations. There are six long bands in which the rubber tubing measures approximately 16″. These six long bands come in three different resistance weights: two light-weight bands, two medium-weight bands, and two heavy-weight bands. These long resistance bands are used for exercises that require a longer range of motion. There are six short resistance bands in which the rubber tubing measures approximately 6″. These six short bands also come in three different resistance weights: two light-weight bands, two medium-weight bands, and two heavy-weight bands. These shorter resistance bands are used for exercises that require a shorter range of motion.

Another feature of the resistance bands is that multiple bands can be used at the same time. For example, for exercises requiring extra long ranges of motion, the bands can be joined end-to-end. Also, for exercises requiring greater resistance weight, the bands can be doubled up, attached to the same metal rings, and used concurrently.

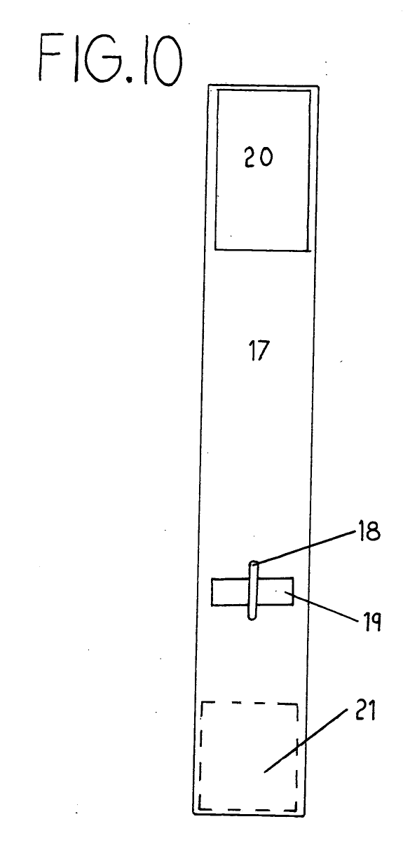

The final pieces included in Hott Matt are a pair of padded handles and a pair of ankle bracelet straps. As seen in FIG. 9, the handles consist of a 18″ long strap of 1″ wide nylon webbing (13) that is run through the middle of a handle grip (14) at one end and a small metal ring (15) at the other end. The handle grip (14) is a 5″ plastic cylinder covered with spongy foam padding (16). Opposite the handle grip, the nylon strap is stitched together behind the small metal ring (15) to keep the metal ring from sliding after the handle grip is hooked up to the resistance cable via the carabiner.

As seen in FIG. 10, each ankle bracelet strap (17) has a metal ring (18) attached to it with the use of a 1.25″ long piece of 0.75″ wide nylon webbing (19) that is passed through the ring and then sewn onto the side of the ankle strap (17). This metal ring (18) is used to hook onto a carabiner at the end of a resistance cable. The ankle strap (17) itself is a piece of 1.5″ wide nylon webbing that is approximately 15″ long with velcro sewn onto each end. There is a piece of coarse velcro approximately 2.5″ long (20) sewn onto the outside of one end of the strap, and a piece of soft velcro approximately 5″ long (21) sewn onto the inside of the opposite end of the nylon ankle strap. The strap is secured around the ankle by overlapping the soft velcro (21) over the top of the coarse velcro (20) and pressing the two pieces together.

It will be apparent that various changes and modifications can be made without departing from the general scope of the invention. First and foremost, different materials could be used to make the mat and accompanying components. For example, plastic parts could be substituted for all of the metal parts or a different type of padding other than foam could be used to pad the mat. Concerning the resistance bands, different styles of hooks-other than carabiners (11)—could be used to fasten the bands to the mat. As far as the attachments go, something other than handles (FIG. 9) and ankle straps (FIG. 10) could be used as resistance band attachments like metal workout bars. Also, the rubber resistance bands (FIG. 8) could be replaced with retractable belts or cables. Finally, a different pattern or number of nylon straps and metal rings (FIG. 2) could be used on the mat, and something other than velcro could be used to fasten the belt straps (3) or ankle straps (17).

The embodiments of the invention in which an exclusive property or privilege is claimed are defined as follows:

1. The invented workout kit includes a tri-fold foam exercise mat wherein the improvement comprises the addition of nylon straps sewn onto the underside of the exercise mat at specific locations.

2. The combination combined in claim 1, wherein nylons straps sewn to the underside of the mat allow for metal rings to be attached to the sides of the mat from which resistance bands can be connected.

3. The combination combined in claim 1, wherein nylon straps sewn to the underside of the mat allow for the mat itself to be anchored down to a separate solitary object.

4. The invented workout kit includes resistance band tubing wherein the improvement comprises the addition of lightweight metal carabiner clips attached to either end of the resistance band for easy connectivity to supplied metal rings.

5. The invented workout kit includes hand and ankle attachments wherein the improvement comprises addition of metal rings from which lightweight metal carabiner clips on the ends of the resistance tubing can be connected.
